(19) United States
(12) Patent Application Publication
(10) Pub. No.: US 2026/0285028 A1
(43) Pub. Date: Sep. 24, 2026

(54) Fan system for screen printer head

(71) Applicant: Captain Cool, LLC, Baltimore, MD (US)

(72) Inventors: Andrew Justin MILLMAN, Hampstead, MD (US); Frederick Donald BECKER, Hampstead, MD (US); Tyler S. IVY, Hanover, PA (US)

(73) Assignee: Captain Cool, LLC, Baltimore, MD (US)

(21) Appl. No.: 19/569,044

(22) Filed: Mar. 17, 2026

Related U.S. Application Data
(60) Provisional application No. 63/774,161, filed on Mar. 19, 2025.
(60) Provisional application No. 64/000,565, filed on Mar. 9, 2026.

(51) Int. Cl. B41F 15/12; B41F 23/04

(52) U.S. Cl. CPC B41F 15/12; B41F 23/0476

(57) ABSTRACT

A cooling system for a screen printing machine includes a housing, at least one fan, and at least one mount structure. The housing including at least one inlet opening and at least one outlet duct. Each electrically driven fan being configured within an inlet opening to direct airflow towards the at least one outlet duct. The mount structure being connected to and extending from the housing and being configured to removably connect the cooling system to the print head.

### CROSS REFERENCES AND PRIORITIES

This application claim priority from U.S. Provisional Application No. 63/774,161 filed on 19 Mar. 2025 and U.S. Provisional Application No. 64/000,565 filed on 9 Mar. 2026, the teachings of each of which are incorporated by reference herein in their entirety.

### BACKGROUND

Screen printing involves a mesh (or screen) used to transfer patterned ink onto a substrate such as paper, metal, wood, plastic, or fabric (often in the form of shirts, hats, and the like) to form an image. Stencils are used to block areas in the mesh where ink is not desired for a particular pattern or in a particular ink color. A blade or squeegee moves across the screen to fill the open mesh apertures with ink followed by a reverse stroke which causes the screen to touch the substrate momentarily, pulling the ink from the mesh apertures to wet the substrate and apply the ink in the pattern indicated by the stencil. Once the ink has been deposited on the substrate, a flash cure step may apply heat to the substrate—often utilizing an infrared heating element or quartz bulb—to partially cure the ink on the substrate.

Screen printing often utilizes multiple stations with each station having its own unique mesh, stencil, blade/squeegee, and color ink. In doing so, multiple colors of ink may be deposited onto the substrate at each station providing for a multi-colored image on the finished substrate.

When a flash cure step is utilized, particularly in screen printing involving multiple stations, it may be desirable to cool the substrate and/or print head following the flash cure step. Doing so prevents hot ink from sticking to the mesh screens during subsequent printing steps and thereby ensures proper ink drying and adhesion.

The simplest method for cooling following a flash cure step involves allowing the substrate and/or print head to naturally cool by exposure to ambient temperature and pressure. This process can take an extended period of time resulting in delays in the screen printing process. Often, screen printing machines will utilize one or more of the stations as a flash and/or cooling stations which is not configured to apply ink to the substrate, but instead is utilized strictly for flash curing and cooling the substrate. Such configurations are considered undesirable as they remove one or more stations from having the ability to apply ink to the substrate resulting in a larger screen printing machine footprint which is utilized to print less colors.

To improve efficiency in the screen printing process, several devices have been developed. One such device is a Cooling Fan Module from Anatol Equipment Manufacturing Co. of Waukegan, Illinois, U.S.A. The Cooling Fan Module attaches to the print carriage and travels back and forth over the substrate along with the blade/squeegee. However, the Cooling Fan Module operates by blowing air away from the print head and towards the substrate which still requires separate flash and/or cooling station(s) within the screen printing machine and does not allow the screen printing machine to utilize the same print head for printing a color.

The need exists, therefore, for a system and method for cooling a flashed print on a screen printing machine while being able to utilize the same print head for printing a color and which reduces cooling time without requiring a separate flash and/or cooling station in the screen printing machine.

### SUMMARY

Described herein is a cooling system for a screen printing machine. The cooling system including a housing, at least one fan, and at least one mount structure. The housing having at least one inlet opening and at least one outlet duct. Each fan being configured within an inlet opening of the housing to direct airflow towards the at least one outlet duct. The at least one mount structure connected to and extending from the housing and configured to removably connect the cooling system to a print head.

In some embodiments, the housing may include an inlet panel, an outlet panel, and a plurality of side panels. In such embodiments, the inlet panel may include at least one inlet panel opening, the outlet panel may include the at least one outlet duct, and each side panel may span a distance between the inlet panel and the outlet panel to form an enclosed space. In certain embodiments, the plurality of side panels may include an upper panel, a lower panel, a first side panel, and a second side panel. When present, the upper panel may extend between an inlet panel upper edge and an outlet panel upper edge. If present, the lower panel may extend between an inlet panel lower edge and an outlet panel lower edge. When present, the first side panel may extend between an inlet panel leading edge and an outlet panel leading edge. If present, the second side panel may extend between an inlet panel trailing edge and an outlet panel trailing edge.

In certain embodiments, the at least one mount structure may include a first arm extending upwardly from the housing. In such embodiments, a first appendage may extend forward from a first arm terminal end while a first clamp member may be connected to a first appendage terminal end and may be configured to removably clamp the cooling system to the print head.

In some embodiments, the at least one mount structure may include a second arm extending upwardly from the housing. In such embodiments, a second appendage may extend forward from a second arm terminal end while a second clamp member may be connected to a second appendage terminal end and may be configured to removably clamp the cooling system to the print head.

In certain embodiments, the at least one inlet panel opening may include at least three inlet panel openings. In such embodiments, the at least one fan may include at least three fans.

In some embodiments, each fan may be configured to have an airflow in a range of between 150 and 400 CFM. In certain embodiments, each fan may include a fan guard extending about the inlet panel opening and connected to the inlet panel. In some embodiments, the at least one fan may be selected from the group consisting of an electrically driven fan and a pneumatically driven fan.

Further described herein are other embodiments of a cooling system with a cooling system stand. These embodiments of the cooling system include a housing, at least one fan, at least one mount structure, and a cooling system stand. The housing having at least one inlet opening and at least one outlet duct. Each fan being configured within an inlet opening of the housing to direct airflow towards the at least one outlet duct. The at least one mount structure connected to and extending from the housing and is configured to connect to the cooling system stand. The cooling system stand is configured to be placed against a print head of a screen printing machine.

In these other embodiments, the housing may include an inlet panel, an outlet panel, and a plurality of side panels. In such embodiments, the inlet panel may include at least one inlet panel opening, the outlet panel may include the at least one outlet duct, and each side panel may span a distance between the inlet panel and the outlet panel to form an enclosed space. In certain embodiments, the plurality of side panels may include an upper panel, a lower panel, a first side panel, and a second side panel. When present, the upper panel may extend between an inlet panel upper edge and an outlet panel upper edge. If present, the lower panel may extend between an inlet panel lower edge and an outlet panel lower edge. When present, the first side panel may extend between an inlet panel leading edge and an outlet panel leading edge. If present, the second side panel may extend between an inlet panel trailing edge and an outlet panel trailing edge.

In these other embodiments, the at least one mount structure is connected to and extends from the housing. The at least one mount structure may comprise a mount structure base, a first arm extending upwardly from a mount structure base leading end, a second arm extending upwardly from a mount structure base trailing end, and at least one mount structure through hole. The first arm has a first arm terminal end which attaches to a first side panel of the housing. The second arm has a second arm terminal end which attaches to a second side panel of the housing.

In these other embodiments, the cooling system may comprise a stand base having a stand base top surface, a stand base bottom surface opposite of the stand base top surface and a stand base perimeter, at least one stand leg having a stand leg top and a stand leg bottom opposite of the stand leg top, a stand upper panel having a stand upper panel top surface, a stand upper panel bottom surface opposite of the stand upper panel top surface, a stand upper panel perimeter, and at least one stand upper panel through hole. The at least one stand leg bottom is attached to the stand base top surface and the stand upper panel is attached to the at least one stand leg top. The at least one stand fastener is configured to connect the at least one mount structure to the stand upper panel top surface. The cooling system stand is configured to position the cooling system in front of the print head. In some embodiments, the cooling system stand may further include at least one caster attached to the stand base bottom surface.

In these other embodiments, the cooling system may further include at least one cooling system guide. The cooling system guide may comprise a first cooling system guide which comprises a first guide arm attached to the first arm of the mount structure, a first guide extension extending from a first guide arm terminal end, a first guide appendage extending from a first guide extension terminal end, and a first handle attached to a first guide appendage terminal end. The at least one cooling system guide may further comprise a second cooling system guide which comprises a second guide arm attached to the second arm of the mount structure, a second guide extension extending from a second guide arm terminal end, a second guide appendage extending from a second guide extension terminal end, and a second handle attached to a second guide appendage terminal end.

In these other embodiments, the at least one inlet panel opening may include at least three inlet panel openings. In such embodiments, the at least one fan may include at least three fans.

In these other embodiments, each fan may be configured to have an airflow in a range of between 150 and 400 CFM. In certain embodiments, each fan may include a fan guard extending about the inlet panel opening and connected to the inlet panel. In some embodiments, the at least one fan may be selected from the group consisting of an electrically driven fan and a pneumatically driven fan.

### BRIEF DESCRIPTION OF FIGURES

FIG. 1 illustrates a perspective view of an exemplary embodiment of a cooling system for a print head of a screen printing machine.

FIG. 2 illustrates an exploded perspective view of an exemplary embodiment of a cooling system for a print head of a screen printing machine.

FIG. 3 illustrates a side cross section view of an exemplary embodiment of a cooling system for a print head of a screen printing machine.

FIG. 4 illustrates an exemplary embodiment of a cooling system being connected to a print head of a screen printing machine.

FIG. 5 illustrates an exemplary embodiment of a cooling system connected to a print head of a screen printing machine.

FIG. 6 illustrates a perspective view of a second exemplary embodiment of a cooling system for a print head of a screen printing machine.

FIG. 7 illustrates an exploded perspective view of a second exemplary embodiment of a cooling system for a print head of a screen printing machine.

FIG. 8 illustrates a side cross section view of a second exemplary embodiment of a cooling system for a print head of a screen printing machine.

FIG. 9 illustrates a second exemplary embodiment of a cooling system being connected to a print head of a screen printing machine.

FIG. 10 illustrates a second exemplary embodiment of a cooling system connected to a print head of a screen printing machine.

### DETAILED DESCRIPTION

Disclosed herein is a cooling system for a print head of a screen printing machine. As described herein, the following numbers refer to the following structures noted in the Figures.
10 refers to a cooling system.
20 refers to a print head (of a screen printing machine).
25 refers to a squeegee/floodbar carriage.
100 refers to a housing.
110 refers to an inlet panel.
111 refers to an inlet panel upper edge.
112 refers to an inlet panel lower edge.
113 refers to an inlet panel leading edge.
114 refers to an inlet panel trailing edge.
115 refers to an inlet panel opening.
120 refers to an outlet panel.
121 refers to an outlet panel upper edge.
122 refers to an outlet panel lower edge.
123 refers to an outlet panel leading edge.
124 refers to an outlet panel trailing edge.
125 refers to an outlet duct.
130 refers to a side panel.
131 refers to an upper panel.
132 refers to a lower panel.
133 refers to a first side panel.
134 refers to a second side panel.
200 refers to a fan.
210 refers to a fan guard.
300 refers to a mount structure.
305 refers to a mount structure base.
306 refers to a mount structure base leading end.
307 refers to a mount structure base trailing end.
310 refers to a first arm.
311 refers to a first arm terminal end.
315 refers to a first appendage.
316 refers to a first appendage terminal end.
318 refers to a first clamp member.
319 refers to a first stop member.
320 refers to a second arm.
321 refers to a second arm terminal end.
325 refers to a second appendage.
326 refers to a second appendage terminal end.
328 refers to a second clamp member.
329 refers to a second stop member.
330 refers to a mount base through hole.
400 refers to a cooling system stand.
405 refers to a stand caster.
410 refers to a stand base.
411 refers to a stand base top surface.
412 refers to a stand base bottom surface.
413 refers to a stand base perimeter.
420 refers to a stand leg.
421 refers to a stand leg top.
422 refers to a stand leg bottom.
425 refers to a stand leg structure.
430 refers to a stand upper panel.
431 refers to a stand upper panel top surface.
432 refers to a stand upper panel bottom surface.
433 refers to a stand upper panel perimeter.
434 refers to a stand upper panel through hole.
440 refers to a stand fastener.
500 refers to a cooling system guide.
510 refers to a first cooling system guide.
515 refers to a first guide arm.
516 refers to a first guide arm terminal end.
520 refers to a first guide extension.
521 refers to a first guide extension terminal end.
530 refers to a first guide appendage.
531 refers to a first guide appendage terminal end.
540 refers to a first handle.
550 refers to a second cooling system guide.
555 refers to a second guide arm.
556 refers to a second guide arm terminal end.
560 refers to a second guide extension.
561 refers to a second guide extension terminal end.
570 refers to a second guide appendage.
571 refers to a second guide appendage terminal end.
580 refers to a second handle.

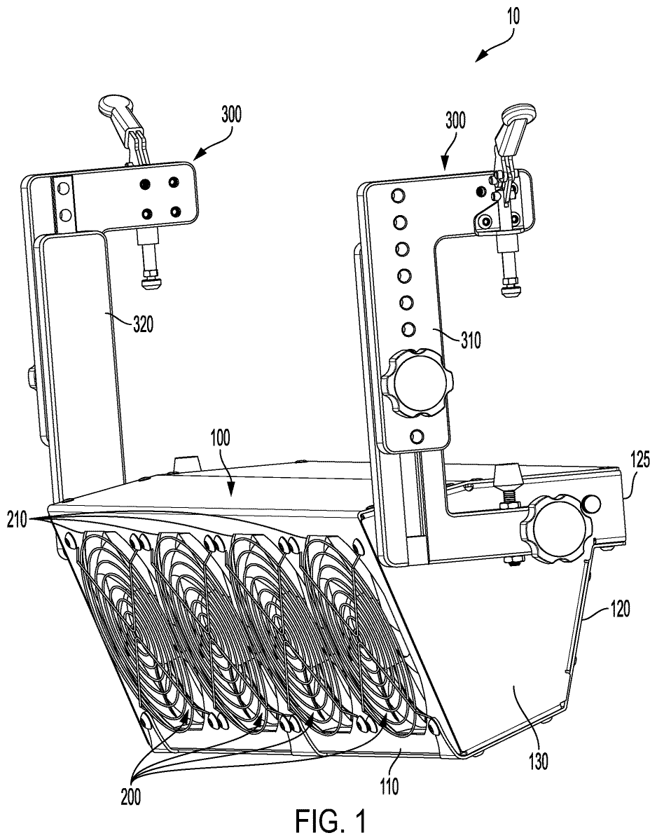

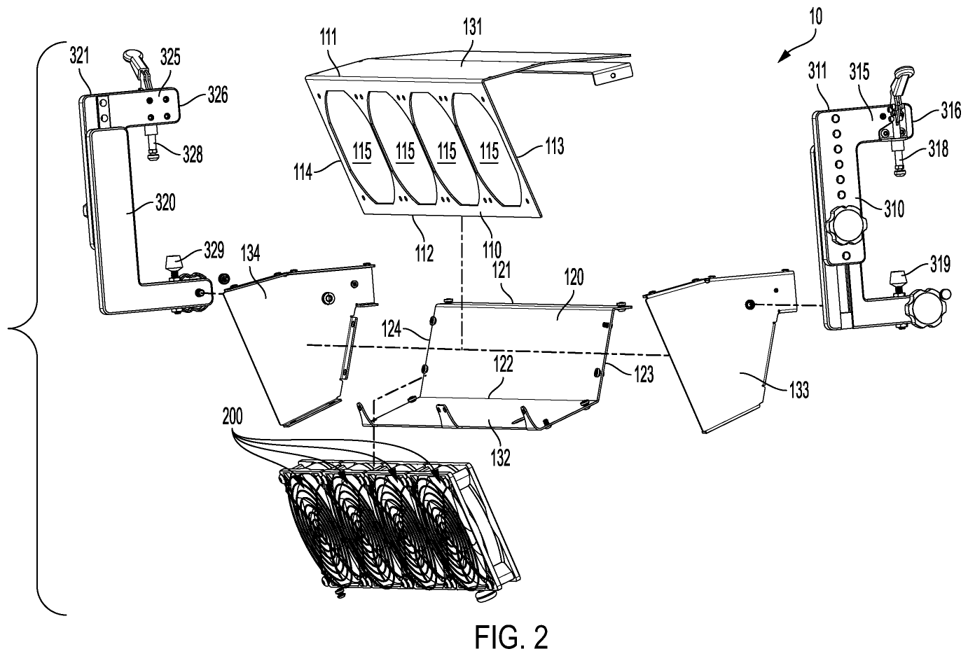

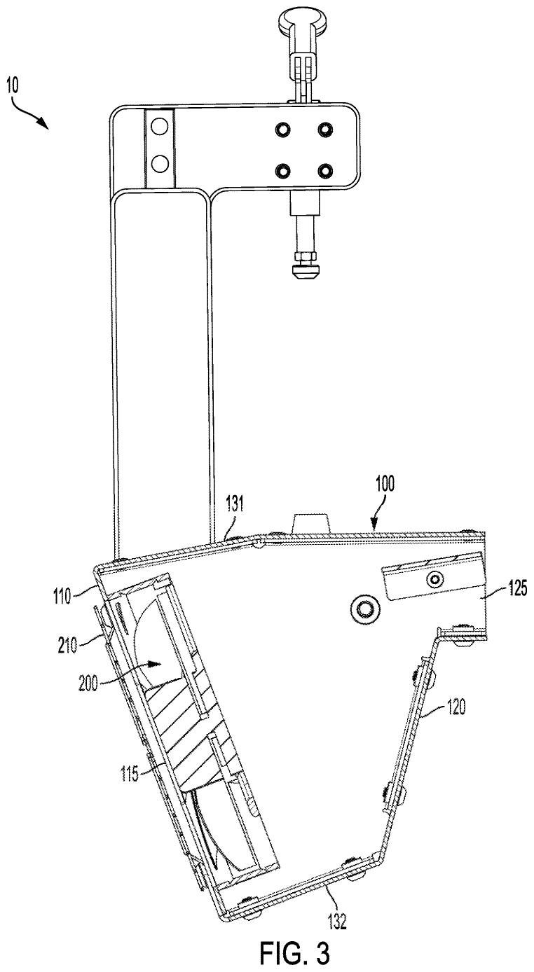

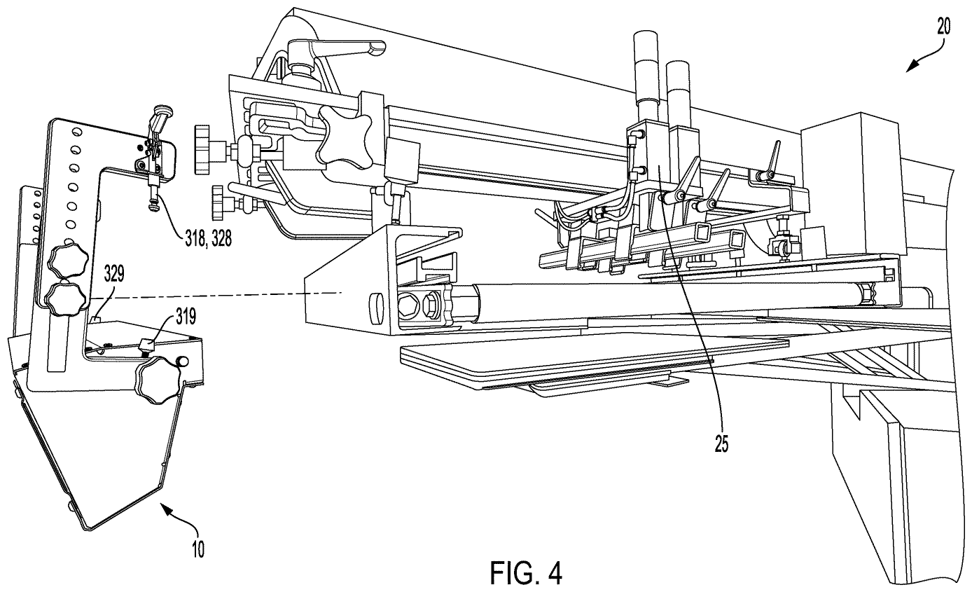

FIG. 1 illustrates an exemplary embodiment of a cooling system (10) for a print head ((20) as shown in FIG. 4) of a screen printing machine in perspective view with FIG. 2 illustrating the exemplary embodiment of a cooling system in exploded perspective view and FIG. 3 illustrating a side cross section view of the exemplary embodiment of a cooling system. As illustrated in FIGS. 1 through 3, the cooling system includes a housing (100), at least one fan (200), and at least one mount structure (300).

In the exemplary embodiment illustrated in FIGS. 1 through 3, the housing (100) includes an inlet panel (110), an outlet panel (120), and a plurality of side panels (130). The various panels, when assembled, provide an enclosed space to direct airflow from the plurality of fans through the housing to exit the housing through an outlet duct (125)—as shown in FIG. 3—which directs at least a portion of the airflow onto the print head ((20) as shown in FIG. 4).

In the exemplary embodiment, the inlet panel (110) has a substantially rectangular shape including an inlet panel upper edge (111), an inlet panel lower edge (112), an inlet panel leading edge (113), and an inlet panel trailing edge (114) forming an inlet panel plane having an inlet panel exterior surface and an inlet panel interior surface. Passing from the inlet panel exterior surface through the inlet panel interior surface is at least one inlet panel opening (115) within which the at least one fan (200) is configured to allow air to enter the interior space of the housing (100) and be accelerated by the fan(s) in the direction of the outlet duct (125) as shown in FIG. 3.

In the exemplary embodiment, the outlet panel (120) has a substantially rectangular shape including an outlet panel upper edge (121), an outlet panel lower edge (122), an outlet panel leading edge (123), and an outlet panel trailing edge (124) forming an outlet panel plane having an outlet panel exterior surface and an outlet panel interior surface. The outlet panel further includes the outlet duct (125) which attached to and extends from the outlet panel such that—when the cooling system (10) is connected to a print head ((20) as shown in FIG. 4)—airflow directed through the housing (100) by the fan(s) (200) exits the housing via the outlet duct—as shown in FIG. 3—with at least a portion of the airflow being directed onto the print head ((20) as shown in FIG. 4).

Each side panel of the plurality of side panels (130) spans a distance between the inlet panel and the outlet panel to form an enclosed space through which airflow may be directed. In the exemplary embodiment shown in FIGS. 1 and 2, the plurality of side panels includes an upper panel (131), a lower panel (132), a first side panel (133), and a second side panel (134). As shown in the exemplary embodiments, the upper panel extends between the inlet panel upper edge (111) and the outlet panel upper edge (121), the lower panel extends between the inlet panel lower edge (112) and the outlet panel lower edge (122), the first side panel extends between the inlet panel leading edge (113) and the outlet panel leading edge (123), and the second side panel extends between the inlet panel trailing edge (114) and the outlet panel trailing edge (124).

When assembled as shown in the exemplary embodiment in FIG. 1, the various panels of the housing (100) form an enclosed space through which airflow is directed by the fan(s) (200). The various panels of the housing may be manufactured of any rigid material such as metals, rigid polymers, woods, and the like using any number of different manufacturing techniques such as cutting, stamping, grinding, welding, injection molding, additive manufacturing (commonly referred to as 3D printing), and the like.

While the exemplary embodiment shown in FIGS. 1 through 3 includes four inlet panel openings (115) and four fans (200) with each fan configured within one of the inlet panel openings, other embodiments may exist. In general, the number of inlet panel openings and the number of fans will each independently be an integer in a range selected from the group consisting of between 1 and 25, between 1 and 20, between 1 and 15, between 1 and 10, between 5 and 25, between 5 and 20, between 5 and 15, between 5 and 10, between 10 and 25, between 10 and 20, and between 10 and 15. Preferably, each inlet panel opening will include one fan configured therein.

Each fan (200) will be configured to have an airflow—measured in cubic feet per minute (CFM). Preferably, the airflow will be in a range selected from the group consisting of between 150 and 400 CFM, between 150 and 350 CFM, between 150 and 300 CFM, between 200 and 400 CFM, between 200 and 350 CFM, between 200 and 300 CFM, between 250 and 400 CFM, between 250 and 350 CFM, and between 250 and 300 CFM. The airflow may be adjusted by changing the dimensions—including number of blades, blade size, and blade pitch—of the fans as well as the fan's rotation speed. In general, each fan of the plurality of fans will have a number of blades in a range selected from the group consisting of between 2 and 8, between 2 and 6, between 3 and 8, between 3 and 6, between 4 and 8, and between 4 and 6. The fans may be selected from the group consisting of electrically driven fans and pneumatically driven fans. In some embodiments, the each fan may include a fan guard (210) extending about the corresponding inlet panel opening and connected to the inlet panel to prevent objects such as human appendages (fingers, hands, etc.) from entering the inlet panel opening and causing damage during operation. When present, the fan guard may take the form of a plurality of bars or similar structures which may connect to the inlet panel by fasteners (screws, rivets, or the like) or may be integrally formed with the inlet panel.

The blades of the fan(s) (200) may be connected to a central shaft which is driven by an electric motor. The electric motor may be electrically connected to a source of electricity by one or more wires. The source of electricity may be a battery (such as a 12 volt battery) or a wall outlet connected to an electric grid. Within the electrical connection between the source of electricity and the electric motor may be an number of devices such as a switch for turning the flow of electricity to the electric motor on and off, a knob which allows for the speed (measured in revolutions per minute (RPM)) to be adjusted, a controller for regulating the flow of electricity to the electric motor, and/or a voltage meter for measuring the amount of electricity flowing to the electric motor.

While FIGS. 1 through 3 illustrate axial fan(s) mounted within inlet opening(s) about the inlet panel of the housing, other embodiments may exist. For example, the cooling system may utilize a centrifugal fan mounted about inlet opening(s) on the side panel(s) of the housing.

In the exemplary embodiment illustrated in FIGS. 1 through 3, the at least one mount structure (300) includes a first arm (310) extending upwardly from the housing (100) with a first appendage (315) extending forward from a first arm terminal end (311). In some embodiments, the first arm may be adjustable along its length such as by fabricating the first arm of two unique sections slideably engaged along their length as shown in FIGS. 1 through 3. A first clamp member (318) being connected to a first appendage terminal end (316) with the first clamp member configured to removably clamp the cooling system (10) to the print head ((20) as shown in FIG. 4). In the exemplary embodiment shown in FIGS. 1 through 3, the first clamp member includes a latch mechanism allowing the clamp member to advance towards and retract away from the housing (100). Alternatively, the first clamp member comprises a threaded rod which passes through a threaded hole in the first appendage terminal end. As the threaded rod extends through the threaded hole in the direction of the housing, the distance between the housing and the proximal end of the threaded rod decreases until the portion of the print head ((20) as shown in FIG. 4) to which the cooling system (10) connects is securely fastened between the housing and the proximal end of the threaded rod. In some embodiments, the first clamp member may include a first stop member (319) extending upwardly from the first arm (310) such that the cooling system securely fastens between the proximal end of the first clamp member and the proximal end of the first lower clamp member.

While some embodiments may include a single mount structure (300), some embodiments—such as those shown in FIGS. 1 to 3—may include two mount structures. As shown in FIGS. 1 to 3, the mount structure includes a second arm (320) extending upwardly from the housing (100) with a second appendage (325) extending forward from a second arm terminal end (321). In some embodiments, the second arm may be adjustable along its length such as by fabricating the second arm of two unique sections slideably engaged along their length as shown in FIGS. 1 through 3. A second clamp member (328) being connected to a second appendage terminal end (326) with the second clamp member configured to removably clamp the cooling system (10) to the print head ((20) as shown in FIG. 4). In the exemplary embodiment shown in FIGS. 1 through 3, the second clamp member includes a latch mechanism allowing the clamp member to advance towards and retract away from the housing (100). Alternatively, the second clamp member comprises a threaded rod which passes through a threaded hole in the second appendage terminal end. As the threaded rod extends through the threaded hole in the direction of the housing, the distance between the housing and the proximal end of the threaded rod decreases until the portion of the screen printing machine to which the cooling system (10) connects is securely fastened between the housing and the proximal end of the threaded rod. In some embodiments, the second clamp member may include a second stop member (329) extending upwardly from the second arm (320) such that the cooling system securely fastens between the proximal end of the second clamp member and the proximal end of the second lower clamp member.

The mount structure(s) (300) may be fabricated of any number of rigid material such as metals, rigid polymers, woods, and the like using any number of different manufacturing techniques such as cutting, stamping, grinding, welding, injection molding, additive manufacturing (commonly referred to as 3D printing), and the like. In some embodiments, the mount structure(s) may be removably attached to the housing (100) by one or more fasteners such as bolts, screws, rivets, clamps, and the like. In some such embodiments, the mount structure(s) may be pivotably attached to the housing allowing the fastener(s) connecting the mount structure(s) to be loosened and the housing to be adjusted to direct the airflow towards different areas of the screen printing machine. Alternatively, the mount structure(s) may be integrally connected to the housing such as by welding, gluing, or manufacturing a portion of the housing and the mount structure of a single integral piece of material.

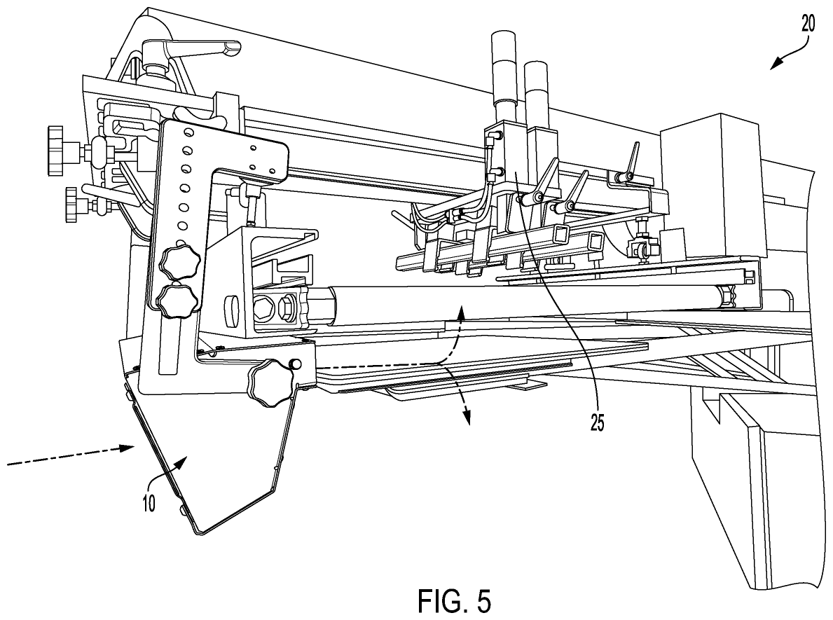

FIGS. 4 and 5 illustrate an exemplary embodiment of the cooling system (10) being connected to a screen printing machine. As shown in FIGS. 4 and 5, the screen printing machine includes a print head (20). Typically the screen printing machine will include frame members surrounding at least a portion of the print head. The cooling system may be connected to the print head by first loosening the clamp member(s) of the mount structure to a position where the distance between the clamp members and the housing is greater than the thickness of the frame member to which the cooling system will be connected. The clamp members may then be loosely placed about the frame member before tightening the clamp members about the frame member to securely connect the cooling system to the frame member.

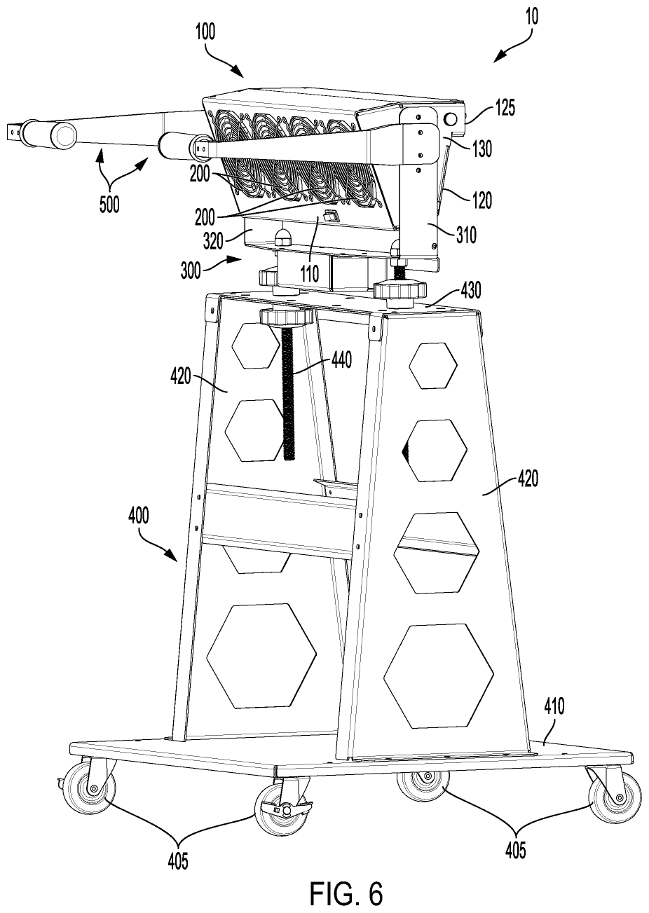

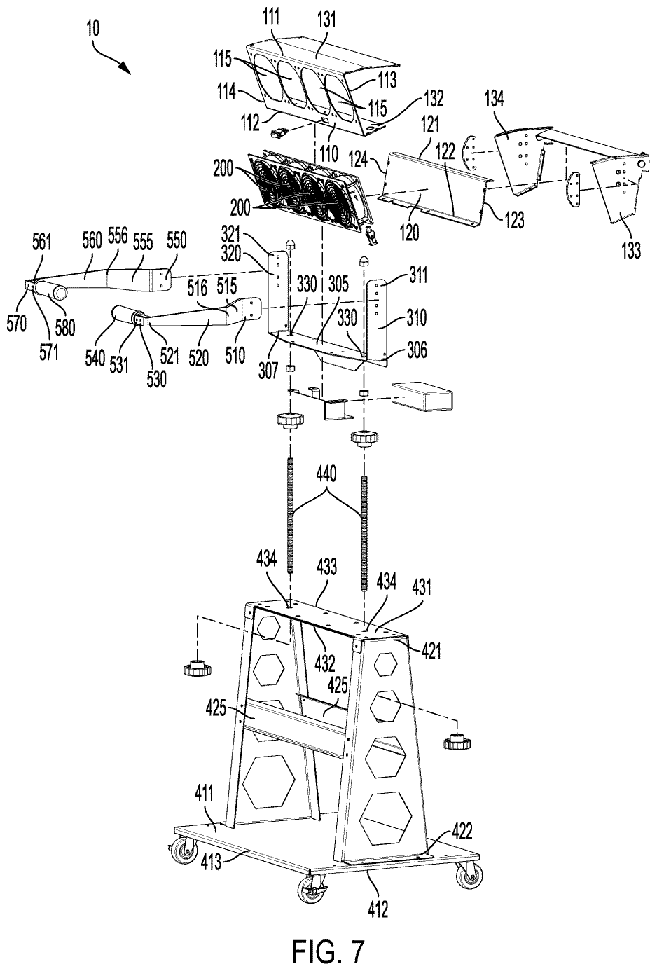

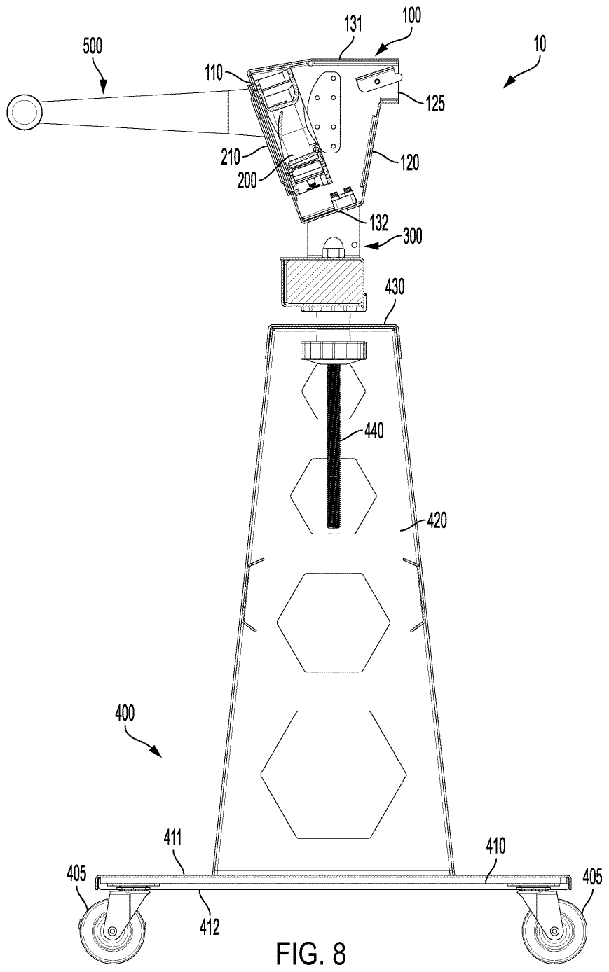

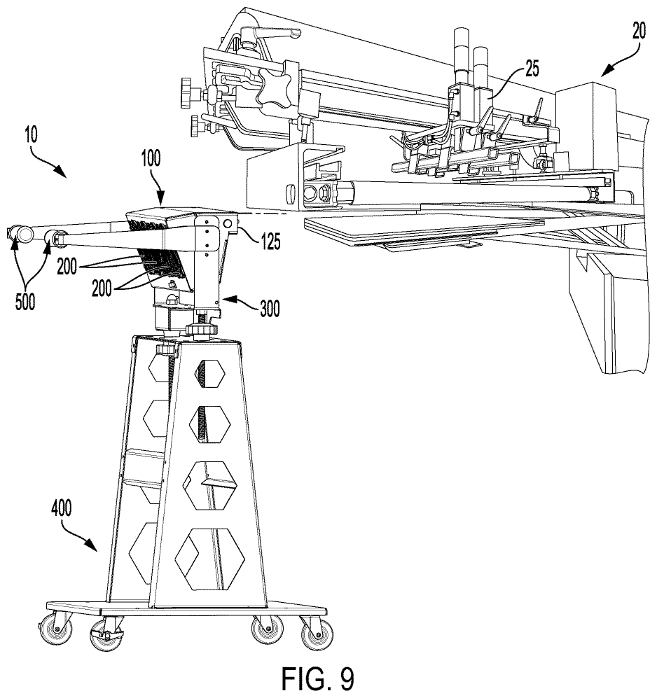

FIG. 6 illustrates a second exemplary embodiment of a cooling system (10) for a print head ((20) as shown in FIG. 9) of a screen printing machine in perspective view with FIG. 7 illustrating the second exemplary embodiment of a cooling system in exploded perspective view and FIG. 8 illustrating a side cross section view of the second exemplary embodiment of a cooling system. As illustrated in FIGS. 6 through 8, the cooling system includes a housing (100), at least one fan (200), at least one mount structure (300), and a cooling system stand (400). The cooling system may further include at least one cooling system guide (500).

In the second exemplary embodiment illustrated in FIGS. 6 to 8, the housing (100) includes an inlet panel (110), an outlet panel (120), and a plurality of side panels (130). The various panels, when assembled, provide an enclosed space to direct airflow from the plurality of fans through the housing to exit the housing through an outlet duct ((125) as shown in FIG. 8) which directs at least a portion of the airflow onto the print head ((20) as shown in FIG. 9).

In the second exemplary embodiment, the inlet panel (110) has a substantially rectangular shape including an inlet panel upper edge (111), an inlet panel lower edge (112), an inlet panel leading edge (113), and an inlet panel trailing edge (114) forming an inlet panel plane having an inlet panel exterior surface and an inlet panel interior surface. Passing from the inlet panel exterior surface through the inlet panel interior surface is at least one inlet panel opening (115) within which the at least one fan (200) is configured to allow air to enter the interior space of the housing (100) and be accelerated by the fan(s) in the direction of the outlet duct ((125) as shown in FIG. 8).

In the second exemplary embodiment, the outlet panel (120) has a substantially rectangular shape including an outlet panel upper edge (121), an outlet panel lower edge (122), an outlet panel leading edge (123), and an outlet panel trailing edge (124) forming an outlet panel plane having an outlet panel exterior surface and an outlet panel interior surface. The outlet panel further includes the outlet duct (125) which attached to and extends from the outlet panel such that—when the cooling system (10) is connected to a print head ((20) as shown in FIG. 9)—airflow directed through the housing (100) by the fan(s) (200) exits the housing via the outlet duct—as shown in FIG. 8—with at least a portion of the airflow being directed onto the print head ((20) as shown in FIG. 9).

Each side panel of the plurality of side panels (130) spans a distance between the inlet panel and the outlet panel to form an enclosed space through which airflow may be directed. In the exemplary embodiment shown in FIGS. 6 and 7, the plurality of side panels includes an upper panel (131), a lower panel (132), a first side panel (133), and a second side panel (134). As shown in the exemplary embodiments, the upper panel extends between the inlet panel upper edge (111) and the outlet panel upper edge (121), the lower panel extends between the inlet panel lower edge (112) and the outlet panel lower edge (122), the first side panel extends between the inlet panel leading edge (113) and the outlet panel leading edge (123), and the second side panel extends between the inlet panel trailing edge (114) and the outlet panel trailing edge (124).

When assembled as shown in the second exemplary embodiment in FIG. 6, the various panels of the housing (100) form an enclosed space through which airflow is directed by the fan(s) (200). The various panels of the housing may be manufactured of any rigid material such as metals, rigid polymers, woods, and the like using any number of different manufacturing techniques such as cutting, stamping, grinding, welding, injection molding, additive manufacturing (commonly referred to as 3D printing), and the like.

While the second exemplary embodiment shown in FIGS. 6 through 8 includes four inlet panel openings (115) and four fans (200) with each fan configured within one of the inlet panel openings, other embodiments may exist. In general, the number of inlet panel openings and the number of fans will each independently be an integer in a range selected from the group consisting of between 1 and 25, between 1 and 20, between 1 and 15, between 1 and 10, between 5 and 25, between 5 and 20, between 5 and 15, between 5 and 10, between 10 and 25, between 10 and 20, and between 10 and 15. Preferably, each inlet panel opening will include one fan configured therein.

Each fan (200) will be configured to have an airflow-measured in cubic feet per minute (CFM). Preferably, the airflow will be in a range selected from the group consisting of between 150 and 400 CFM, between 150 and 350 CFM, between 150 and 300 CFM, between 200 and 400 CFM, between 200 and 350 CFM, between 200 and 300 CFM, between 250 and 400 CFM, between 250 and 350 CFM, and between 250 and 300 CFM. The airflow may be adjusted by changing the dimensions-including number of blades, blade size, and blade pitch-of the fans as well as the fan's rotation speed. In general, each fan of the plurality of fans will have a number of blades in a range selected from the group consisting of between 2 and 8, between 2 and 6, between 3 and 8, between 3 and 6, between 4 and 8, and between 4 and 6. The fans may be selected from the group consisting of electrically driven fans and pneumatically driven fans. In some embodiments, the each fan may include a fan guard (210) extending about the corresponding inlet panel opening and connected to the inlet panel to prevent objects such as human appendages (fingers, hands, etc.) from entering the inlet panel opening and causing damage during operation. When present, the fan guard may take the form of a plurality of bars or similar structures which may connect to the inlet panel by fasteners (screws, rivets, or the like) or may be integrally formed with the inlet panel.

The blades of the fan(s) (200) may be connected to a central shaft which is driven by an electric motor. The electric motor may be electrically connected to a source of electricity by one or more wires. The source of electricity may be a battery (such as a 12 volt battery) or a wall outlet connected to an electric grid. Within the electrical connection between the source of electricity and the electric motor may be an number of devices such as a switch for turning the flow of electricity to the electric motor on and off, a knob which allows for the speed (measured in revolutions per minute (RPM)) to be adjusted, a controller for regulating the flow of electricity to the electric motor, and/or a voltage meter for measuring the amount of electricity flowing to the electric motor.

While FIGS. 6 through 8 illustrate axial fan(s) mounted within inlet opening(s) about the inlet panel of the housing, other embodiments may exist. For example, the cooling system may utilize a centrifugal fan mounted about inlet opening(s) on the side panel(s) of the housing.

In the second exemplary embodiment illustrated in FIGS. 6 through 8, the mount structure (300) includes mount structure base (305), a first arm (310) extending upwardly from a mount structure base leading end (306), a second arm (320) extending upwardly from a mount structure base trailing end (307), and at least one mount structure through hole (330). The first arm has a first arm terminal end (311) which attaches to a first side panel (133) of the housing (100). The second arm has a second arm terminal end (321) which attaches to a second side panel (134) of the housing.

The mount structure (300) shown in FIGS. 6 through 8 may be fabricated of any number of rigid material such as metals, rigid polymers, woods, and the like using any number of different manufacturing techniques such as cutting, stamping, grinding, welding, injection molding, additive manufacturing (commonly referred to as 3D printing), and the like.

In some embodiments, the first arm terminal end (311) and the second arm terminal end (321) of the mount structure (300) may be removably attached to the housing (100) by one or more fasteners such as bolts, screws, rivets, clamps, and the like. In some such embodiments, the first arm terminal end and the second arm terminal end of the mount structure may be pivotably attached to the housing allowing the fastener(s) connecting the mount structure to be loosened and the housing to be adjusted to direct the airflow towards different areas of the screen printing machine. Alternatively, the first arm terminal end and the second arm terminal end of the mount structure may be integrally connected to the housing such as by welding, gluing, or manufacturing a portion of the housing and the mount structure of a single integral piece of material.

In the second exemplary embodiment illustrated in FIGS. 6 through 8, the cooling system stand (400) has a stand base (410), at least one stand leg (420), and a stand upper panel (430). The stand base includes a stand base top surface (411) and a stand base bottom surface (412) opposite of the stand base top surface, and a stand base perimeter (413). In some embodiments, such as the second exemplary embodiment shown in FIGS. 6 through 8, there may be a plurality of casters (405) attached to the stand base bottom surface.

The at least one stand leg (420) has a stand leg top (421) and a stand leg bottom (422) opposite of the stand leg top. The stand leg bottom is attached to the stand base top surface (411). The stand leg bottom may be attached at any point of the stand base top surface, but preferably the stand leg bottom is attached near the stand base perimeter (413). If more than one stand leg is present, for each pair of stand legs, one stand leg bottom is attached near the stand base perimeter opposite the side where the second stand leg bottom is attached near the stand base perimeter. The stand leg bottom may be integral with the stand base top surface through casting, molding, additive manufacturing, forging, CNC machining, or the like. Alternatively, the stand leg bottom may be attached to the stand base by welding, fastening (by bolts, screws, rivets, clamps, or the like), adhesive, and the like.

If there is more than one stand leg (420) present, at least one stand leg beam (425) may span between each stand leg for additional structure. The stand leg beam may be located at any point along the height of the stand legs, but is preferably located at the midpoint along the height of the stand legs. The at least one stand leg beam may be integral with the stand legs through casting, molding, additive manufacturing, forging, CNC machining, or the like. Alternatively, the at least one stand leg beam may be attached to the stand legs by welding, fastening (by bolts, screws, rivets, clamps, or the like), adhesive, and the like.

The stand upper panel (430) has a stand upper panel top surface (431), a stand upper panel bottom surface (432), a stand upper panel perimeter (433), and at least one stand upper panel through hole (434). The stand upper panel attaches to the stand leg top (421) of each stand leg (420) present. The second exemplary embodiment in FIGS, 6 through 8 shows two stand legs with each end of the stand upper panel attached to the stand leg tops. The stand upper panel may be integral with the stand leg top(s) through casting, molding, additive manufacturing, forging, CNC machining, or the like. Alternatively, the stand upper panel may be attached to the stand leg top(s) by welding, fastening (by bolts, screws, rivets, clamps, or the like), adhesive, and the like.

The second exemplary embodiment of the cooling system (10) shown in FIGS. 6 through 8 includes at least one stand fastener (440) which passes through the mount structure through hole(s) (330) and the stand upper panel through hole(s) (434), thereby attaching the mount structure (300) to the stand upper panel (430). The at least one stand fastener is selected from a group consisting of a bolt, a screw, a pin, a nail, a rivet, and the like. Though the second exemplary embodiment shows the use of stand fasteners, the mount structure may be attached directly to the stand upper panel. Alternatively, the mount structure may be integral with the stand upper panel through casting, molding, additive manufacturing, forging, CNC machining, or the like.

FIGS. 6 through 8 further illustrate the cooling system (10) further including at least one cooling system guide (500). The second exemplary embodiment shown displays the cooling system having a first cooling system guide (510) and a second cooling system guide (550). The first cooling system guide includes a first guide arm (515) attached to the first arm (310), a first guide extension (520) extending from a first guide arm terminal end (516), a first guide appendage (530) extending from a first guide extension terminal end (521), and a first handle (540) attached to a first guide appendage terminal end (531). The second cooling system guide includes a second guide arm (555) attached to the second arm (320), a second guide extension (560) extending from a second guide arm terminal end (556), a second guide appendage (570) extending from a second guide extension terminal end (561), and a second handle (580) attached to a second guide appendage terminal end (571).

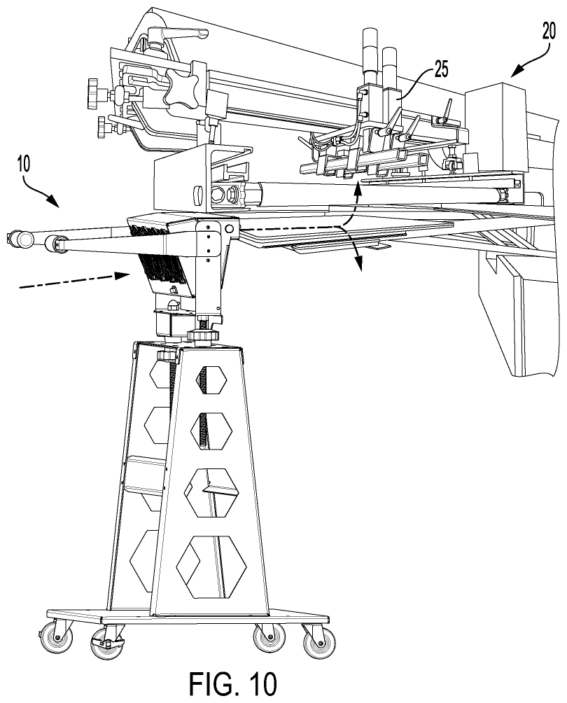

FIGS. 9 and 10 illustrate a second exemplary embodiment of the cooling system (10) against a screen printing machine. As shown in FIGS. 9 and 10, the screen printing machine includes a print head (20). Typically the screen printing machine will include frame members surrounding at least a portion of the print head. The cooling system may be manually placed against the print head by maneuvering the cooling system stand (400) by the cooling system guide(s) (500). If the stand base bottom surface (412) includes a plurality of casters, the cooling system can be rolled up against the print head by maneuvering the cooling system stand by the cooling system guide(s).

The system and method described herein provides for cooling the substrate more rapidly thereby improving timing and efficiency of the screen printing process when compared to simply allowing the print head and/or substrate to cool naturally at ambient temperature and pressure. The housing may be positioned on the screen printing machine to provide cool airflow from the fan(s) onto or over the print head and/or substrate following the flash cure step. In doing so, the ink deposition, flash cure, and cooling may be accomplished at a single station, thereby eliminating the need for screen printers to set aside a separate station on their machine for flash curing and cooling and allowing the screen printing machine to utilize the same print head for printing a color.

While the cooling system have been described as having one or more exemplary designs, the system may be further modified within the spirit and scope of this disclosure. This application is therefore intended to cover any variations, uses, or adaptations of the cooling system using its general principles.

What is claimed is:

1. A cooling system (10) for a screen printing machine, said cooling system comprising:
a housing (100) having at least one inlet opening and at least one outlet duct (125);
at least one fan (200) with each fan configured within an inlet opening of the housing to direct airflow towards the at least one outlet duct; and
at least one mount structure (300) connected to and extending from the housing and configured to removably connect the cooling system to a print head (20).

2. The cooling system of claim 1, wherein the housing comprises:
an inlet panel (110) having at least one inlet panel opening (115);
an outlet panel (120) having the at least one outlet duct; and
a plurality of side panels (130) with each side panel spanning a distance between the inlet panel and the outlet panel to form an enclosed space.

3. The cooling system of claim 2, wherein the plurality of side panels comprises:
an upper panel (131) extending between an inlet panel upper edge (111) and an outlet panel upper edge (121);
a lower panel (132) extending between an inlet panel lower edge (112) and an outlet panel lower edge (122);
a first side panel (133) extending between an inlet panel leading edge (113) and an outlet panel leading edge (123); and
a second side panel (134) extending between an inlet panel trailing edge (114) and an outlet panel trailing edge (124).

4. The cooling system of claim 1, wherein the at least one mount structure comprises a first arm (310) extending upwardly from the housing, a first appendage (315) extending forward from a first arm terminal end (311), and a first clamp member (318) connected to a first appendage terminal end (316) and configured to removably clamp the cooling system to the print head.

5. The cooling system of claim 1, wherein the at least one mount structure comprises a second arm (320) extending upwardly from the housing, a second appendage (325) extending forward from a second arm terminal end (321), and a second clamp member (328) connected to a second appendage terminal end (326) and configured to removably clamp the cooling system to the print head.

6. The cooling system of claim 2, wherein the at least one inlet panel opening includes at least three inlet panel openings and the at least one fan includes at least three fans.

7. The cooling system of claim 1, wherein each fan is configured to have an airflow in a range of between 150 and 400 CFM.

8. The cooling system of claim 2, wherein each fan of includes a fan guard (210) extending about the inlet panel opening and connected to the inlet panel.

9. The cooling system of claim 1, wherein the at least one fan is selected from the group consisting of an electrically driven fan and a pneumatically driven fan.

10. A cooling system for a screen printing machine, said cooling system comprising:
a housing having at least one inlet opening and at least one outlet duct;
at least one fan with each fan configured within an inlet opening of the housing to direct airflow towards the at least one outlet duct;
at least one mount structure having at least one mount structure through hole (330);
a cooling system stand (400) comprising:
a stand base (410) having a stand base top surface (411), a stand base bottom surface (412) opposite of the stand base top surface and a stand base perimeter (413);
at least one stand leg (420) having a stand leg top (421) and a stand leg bottom (422) opposite of the stand leg top;
a stand upper panel (430) having a stand upper panel top surface (431), a stand upper panel bottom surface (432) opposite of the stand upper panel top surface, a stand upper panel perimeter (433), and at least one stand upper panel through hole (434);
wherein the at least one mount structure is connected to and extends from the housing;
wherein the stand leg bottom of the at least one stand leg is attached to the stand base top surface;
wherein the stand upper panel is attached to the stand leg top of the at least one stand leg;
wherein at least one stand fastener (440) is configured to connect the at least one mount structure to the stand upper panel top surface; and
wherein the cooling system stand is configured to position the cooling system in front of a print head.

11. The cooling system of claim 10, wherein the housing comprises:
an inlet panel having at least one inlet panel opening;
an outlet panel having the at least one outlet duct; and
a plurality of side panels with each side panel spanning a distance between the inlet panel and the outlet panel to form an enclosed space.

12. The cooling system of claim 11, wherein the plurality of side panels comprises:
an upper panel extending between an inlet panel upper edge and an outlet panel upper edge;
a lower panel extending between an inlet panel lower edge and an outlet panel lower edge;
a first side panel extending between an inlet panel leading edge and an outlet panel leading edge; and
a second side panel extending between an inlet panel trailing edge and an outlet panel trailing edge.

13. The cooling system of claim 11, wherein the at least one inlet panel opening includes at least three inlet panel openings and the at least one fan includes at least three fans.

14. The cooling system of claim 10, wherein each fan is configured to have an airflow in a range of between 150 and 400 CFM.

15. The cooling system of claim 11, wherein each fan of includes a fan guard extending about the inlet panel opening and connected to the inlet panel.

16. The cooling system of claim 10, wherein the at least one fan is selected from the group consisting of an electrically driven fan and a pneumatically driven fan.

17. The cooling system of claim 10, further comprising at least one cooling system guide (500) attached to the mount structure.

18. The cooling system of claim 17, wherein the at least one cooling system guide comprises:
a first cooling system guide (510) comprising:
a first guide arm (515) attached to a first arm of the mount structure;
a first guide extension (520) extending from a first guide arm terminal end (516);
a first guide appendage (530) extending from a first guide extension terminal end (521); and
a first handle (540) attached to a first guide appendage terminal end (531); and
a second cooling system guide (550) comprising:
a second guide arm (555) attached to a second arm of the mount structure;
a second guide extension (560) extending from a second guide arm terminal end (556);
a second guide appendage (570) extending from a second guide extension terminal end (561); and
a second handle (580) attached to a second guide appendage terminal end (571).

19. The cooling system of claim 10, further comprising at least one caster (405) attached to the stand base bottom surface.

20. The cooling system of claim 10, wherein the at least one stand fastener is selected from a group consisting of a bolt, a screw, a pin, a nail, and a rivet.
